(19) United States
(12) Patent Application Publication
(10) Pub. No.: US 2014/0139662 A1
(43) Pub. Date: May 22, 2014

(54) MONITORING DEVICE, HANDHELD DEVICE AND MONITORING METHOD

(71) Applicant: HON HAI PRECISION INDUSTRY CO., LTD., New Taipei (TW)

(72) Inventor: CHIH-CHUN CHANG, New Taipei (TW)

(73) Assignee: HON HAI PRECISION INDUSTRY CO., LTD., New Taipei (TW)

(21) Appl. No.: 14/068,040

(22) Filed: Oct. 31, 2013

(30) Foreign Application Priority Data
Nov. 21, 2012 (TW) 101143584

(51) Int. Cl. G08B 13/196

(52) U.S. Cl. CPC G08B 13/19695
USPC 348/143

(57) ABSTRACT

A monitoring device communicates with a handheld device and at least one image capturing device, the handheld device is capable of communicating with the image capturing device. The monitoring device responds with a warning signal from the handheld device and controls the handheld device to detect whether the image capturing device is connected with the handheld device, and obtains the identification information of the image capturing device when the image capturing device is detected to be connected with the handheld device, and further controls the image capturing device to capture video and/or image of the emergency scene surrounding the handheld device according to the identification. As a result, the user of the monitoring device can get a visual of the emergency scene. A handheld device and a monitoring method are also provided.

### BACKGROUND

1. Technical Field

The present disclosure relates to electronic devices, and particularly to a monitoring device and a handheld device and a monitoring method.

2. Description of Related Art

When an emergency occurs, most people always call the emergency service via phone. In that way, the emergency service can only get voice information from the person making the call and cannot see the scene of the emergency. And if the calling person is unable to speak, the emergency service cannot get any information of the calling person.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a monitoring device assembly including a handheld device and a number of image capturing devices.

FIG. 2 is a flowchart of a monitoring method of the monitoring device assembly.

### DETAILED DESCRIPTION

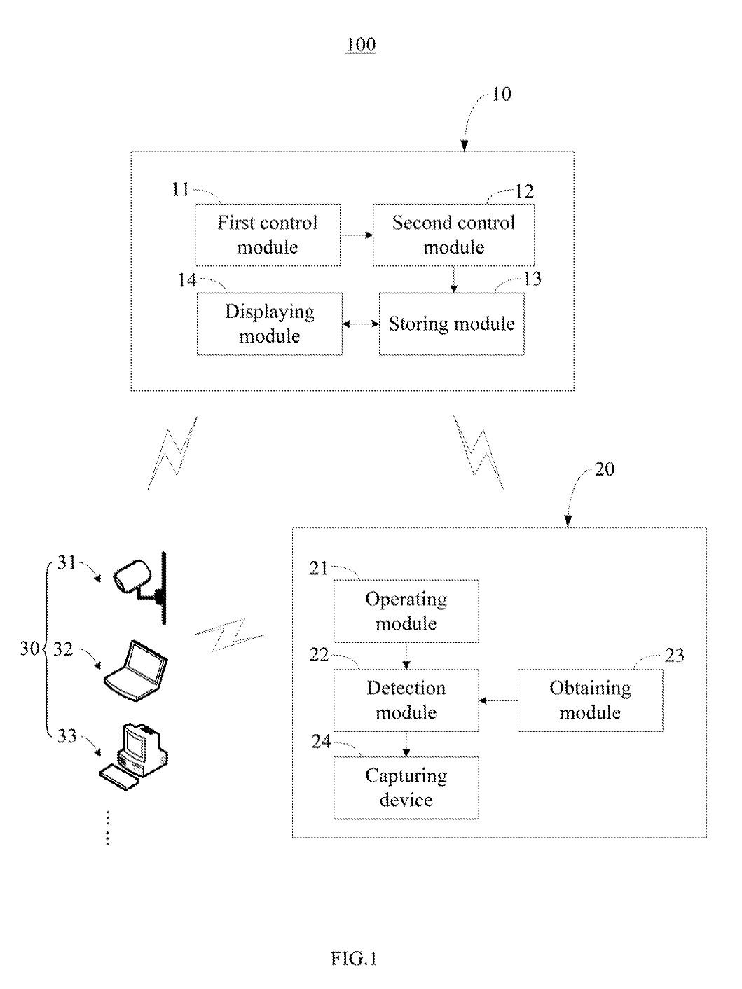

FIG. 1 illustrates an embodiment of a monitoring device assembly 100. The monitoring device assembly 100 includes a monitoring device 10, a handheld device 20 and at least one image capturing device 30. The monitoring device 10 can be a computer. The handheld device 20 can be a mobile phone, a personal digital assistant (PDA), or the like. The handheld device 20 communicates with the monitoring device 10 wirelessly, such as by Global System of Mobile communication (GSM), Code Division Multiple Access (CDMA), Wireless Fidelity (WI-FI), or the like. In the embodiment, the handheld device 20 is a mobile phone which comprises a capturing device 24.

The image capturing device 30 communicates with the monitoring device 10 wirelessly. The image capturing device 30 captures video and/or image of the emergency scene surrounding the handheld device in response to the operation of the monitoring device 10. The image capturing device 30 can be independent from the handheld device 20, for example, a monitoring camera, a laptop with a camera, a computer with a camera, or the like; or can be integrated within the handheld device 20, for example, a camera of a mobile phone or tablet. In this embodiment, the image capturing devices includes a monitoring camera 31, a laptop 32, a computer 33 (hereafter image capturing device 30 for the monitoring camera 31, the notebook 32 and the computer 33), and the capturing device 24 of the handheld device 20. In this embodiment, the image capturing devices 30 which are independent from the handheld device 20 are connected to the wireless network via a number of wireless routers, which are connected to the monitoring device 10.

The monitoring device 10 includes a first control module 11, a second control module 12, a storing module 13 and a displaying module 14. The handheld device 20 includes an operating module 21, a detection module 22, an obtaining module 23 and a capturing device 24.

The operating module 21 generates warning signals in response to manual operation, and sends the warning signals to the first control module 11. In this embodiment, the handheld device 20 includes a number of keys and/or buttons for allowing a user to dial phone numbers, when the user dials a predetermined phone number, the operating module 21 generates the warning signals.

The first control module 11 generates control signals in response to the warning signals. The control signals are used for controlling the image capturing device 30 to capture video and/or images of the emergency scene surrounding the handheld device 20.

The detection module 22 detects whether an image capturing device 30 connects with the handheld device 20 in response to the control signals. When the handheld device 20 is connected to a wireless router which is connected to an image capturing device 30, the image capturing device 30 can be detected by the handheld device 20. When the handheld device 20 is moved and connected to another wireless router which is connected with other image capturing device 30, the other image capturing device 30 can be detected by the handheld device 20.

When the image capturing device 30 is detected to be connected with the handheld device 20, the detection module 22 generates obtaining signals. When no image capturing device 30 is connected with the handheld device 20, the detection module 22 generates first capturing signals.

The obtaining module 23 obtains the identification information of the detected image capturing device 30 in response to the obtaining signals and sends the identification information to the second control module 12. The identification information can be address information, for example, the IP address, the GPS information, or the like.

The second control module 12 generates second capturing signals and sends to the image capturing device 30 according to the identification information, for controlling the detected image capturing device 30 to capture a video and/or an image of the emergency scene and obtaining the captured video and/or image by the image capturing device 30. The second control module 12 further controls the storing module 13 to store the captured video and/or image from the image capturing device 30.

The capturing device 24 captures video and/or image in response to the first capturing signals, and sends the captured video and/or image to the second control module 12. The second control module 12 controls the storing module 13 to store the captured video and/or image from the handheld device 10.

The displaying module 14 displays the captured video and/or image.

Thus, when the user dials a predetermined phone number, the emergency scene surrounding the handheld device 20 can be stored and displayed in the monitoring device 10. As a result, the user of the monitoring device 10 can be aware of the emergency scene.

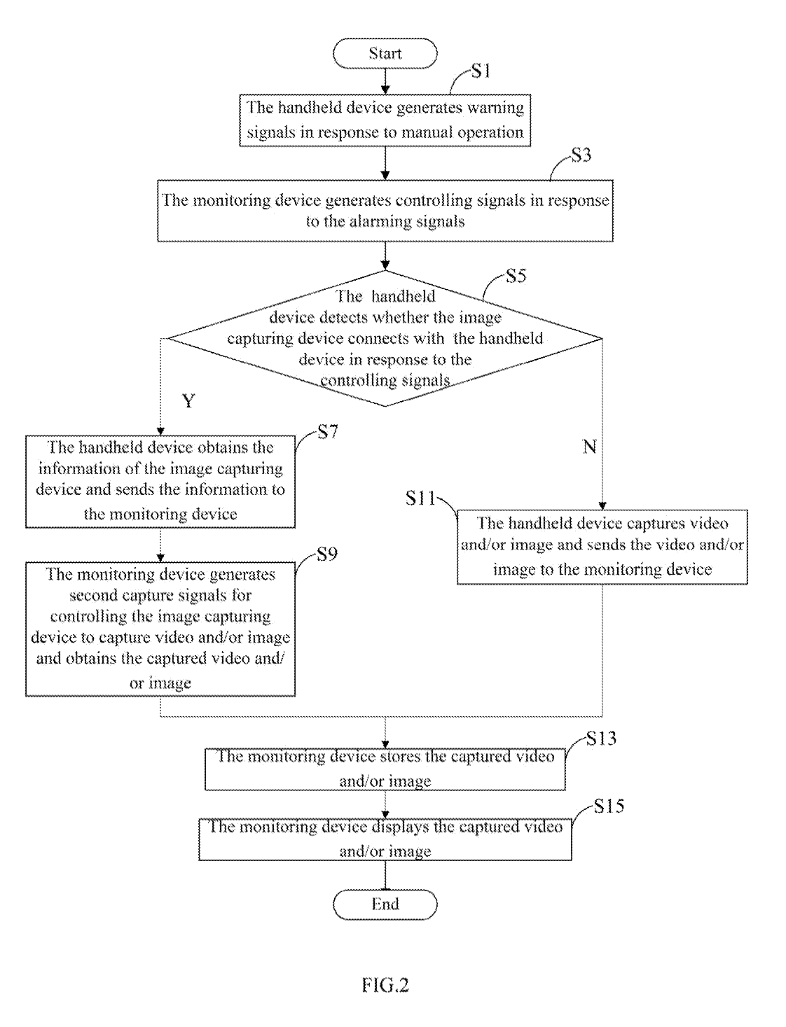

FIG. 2 shows a monitoring method applied to the monitoring device assembly 100 for capturing the emergency scene around the handheld device 20. The monitoring device assembly 100 includes the monitoring device 10, the handheld device 20 comprises a capturing device 24 and the image capturing device 30. The monitoring method includes the following steps:

In step S1, the handheld device 20 generates alarm signals in response to manual operation. In this embodiment, the handheld device 20 includes a number of keys and/or buttons for allowing a user to dial out, when the user dials a predetermined phone number, the operating module 21 generates the warning signals.

In step S3, the monitoring device 10 generates controlling signals in response to the warning signals. The controlling signals are used for controlling the image capturing device 30 to capture video and/or image of the emergency scene surrounding the handheld device 20.

In step S5, the handheld device 20 detects whether an image capturing device 30 connects with the handheld device 20 in response to the controlling signals. When the handheld device 20 is connected to a wireless router which is connected with some image capturing device 30, the image capturing device 30 can be detected by the handheld device 20. When the handheld device 20 is moved and connected to another wireless router which is connected with other image capturing device 30, the others image capturing device 30 can be detected by the handheld device 20.

When the image capturing device is detected to connect with the handheld device 20, step S7 is implemented. When no image capturing device is detected to connect with the handheld device 20, step S11 is implemented.

In step S7, the handheld device 20 obtains the identification information of the detected image capturing device 30 in response to the obtaining signals and sends the identification information to the monitoring device 10. The identification information can be address information, for example, the IP address, the GPS information, for example.

In step S9, the monitoring device 10 generates second capturing signals and sends to the image capturing device 30 according to the information, for controlling the detected image capturing device 30 to capture a video and/or an image of the emergence scene and obtaining the captured video and/or image by the image capturing device 30. And then, step S13 is implemented.

In step S11, the capturing device 24 of the handheld device 20 captures video and/or image and sends the captured video and/or image to the monitoring device 10.

In step S13, the monitoring device 10 stores the captured video and/or image from the handheld device 20 and/or the image capturing device 30.

In step S15, the display module 16 displays the captured video and/or image. As a result, the user of the monitoring device 10 can be aware of the emergency scene.

Although information and the advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A monitoring device communicating with a handheld device and at least one image capturing device, the monitoring device comprising:
a first receiving module receiving an alarming signal from the handheld device; and
a first controlling module controlling the image capturing device to capture video and/or image of the emergency scene surrounding the handheld device, and obtaining the captured video and/or image by the image capturing device in response to the alarming signal.

2. The monitoring device as claimed in claim 1, wherein the image capturing device is independent of the handheld device, the monitoring device further comprises a second controlling module, the second controlling module controlling the handheld device to detect whether the image capturing device connects with the handheld device, and obtaining the identification information of the image capturing device by the handheld device when the image capturing device is detected to be connected with the handheld device, the identification information used by the first controlling module for controlling the image capturing device to capture video and/or image.

3. The monitoring device as claimed in claim 2, wherein the handheld device and the image capturing device are connected to a wireless router, the handheld device detects the image capturing device via the wireless router.

4. The monitoring device as claimed in claim 2, wherein the identification information of the image capturing device is address information.

5. The monitoring device as claimed in claim 4, wherein the address information is an IP address.

6. The monitoring device as claimed in claim 1, further comprising a storing module for storing the captured video and/or image.

7. The monitoring device as claimed in claim 1, wherein the image capturing device is integrated with the handheld device.

8. A handheld device communicating with a monitoring device, the handheld device comprising:
an operating module for generating an alarming signal;
wherein the monitoring device is used for communicating with at least one image capturing device, and controlling the image capturing device to capture video and/or image of an emergency scene surrounding the handheld device, and further obtaining the captured video and/or image by the image capturing device in response to the alarming signal.

9. The handheld device as claimed in claim 8, wherein the image capture device is independent of the handheld device, the handheld device further comprises:
a detection module detecting whether the image capturing device connects with the handheld device in response to a controlling signal from the monitoring device, wherein the monitoring device generates the controlling signal in response to the alarming signal;
an obtaining module for obtaining an identification information of the image capturing device when the image capturing device is detected to be connected with the handheld device;
a sending module for sending the identification information to the monitoring device, wherein the identification information used by the monitoring device for controlling the image capturing device to capture video and/or image.

10. The handheld device as claimed in claim 9, wherein the handheld device and the image capturing device are connected to a wireless router, the handheld device detects the image capturing device via the wireless router.

11. The handheld device as claimed in claim 9, wherein the identification information of the image capturing device is address information.

12. The handheld device as claimed in claim 11, wherein the address information is an IP address.

13. The handheld device as claimed in claim 11, wherein the address information is GPS information.

14. The handheld device as claimed in claim 8, wherein the image capturing device is integrated with the handheld device.

15. A monitoring method used by a monitoring device for capturing video and/or image of scene surrounding a handheld device by at least one capturing image unit, comprising:
receiving an alarming signal from the handheld device; and
controlling the image capturing device to capture video and/or image of the emergency scene surrounding the handheld device, and obtaining the captured video and/or image by the image capturing device in response to the alarming signal.

16. The monitoring method as claimed in claim 15, wherein the image capturing device is independent of the handheld device, the monitoring method further comprises:
controlling the handheld device to detect whether the image capturing device connects with the handheld device, and obtaining the identification information of the image capturing device when the image capturing device is detected to be connected with the handheld device in response to the alarming signal, the identification information used by the monitoring device for controlling the image capturing device to capture video and/or image.

17. The monitoring method as claimed in claim 16, wherein the handheld device and the image capturing device are connected to a wireless router, the handheld device detects the image capturing device via the wireless router.

18. The monitoring method as claimed in claim 17, wherein the identification information of the image capturing device is address information.

19. The monitoring method as claimed in claim 18, wherein the address information is IP address.

20. The monitoring method as claimed in claim 15, wherein the image capturing device is integrated within the handheld device.
